(19) United States
(12) Patent Application Publication
(10) Pub. No.: US 2014/0253432 A1
(43) Pub. Date: Sep. 11, 2014

(54) SENSOR-MONITORED, 3D, INTERACTIVE HOLOGRAPHIC FREESPACE CONTROL UNIT (HFCU) AND ASSOCIATED COMPONENTS

(71) Applicant: Holly Tina Ferguson, Metamora, MI (US)

(72) Inventor: Holly Tina Ferguson, Metamora, MI (US)

(73) Assignee: Holly Tina Ferguson, Metamora, MI (US)

(21) Appl. No.: 14/158,844

(22) Filed: Jan. 19, 2014

Related U.S. Application Data
(60) Provisional application No. 61/754,960, filed on Jan. 21, 2013.

(51) Int. Cl. G03H 1/00; G06F 3/01; G06F 3/0481; G06F 3/03

(52) U.S. Cl. CPC G03H 1/0005; G06F 3/0304; G06F 3/017; G06F 3/04815; G03H 2001/0061
USPC 345/156

(57) ABSTRACT

A sensor/camera-monitored, virtual image or holographic-type display device is provided and called a SENSOR-MONITORED, 3D, INTERACTIVE HOLOGRAPHIC FREESPACE CONTROL UNIT (HFCU). This invention allows user interactions with the virtual-images or holograms without contacting any physical surface; it is achieved via the use of a visually bounded freespace both with and without holographic-type assistance. The 3D Holographic-type Freespace Control Unit (HFCU) and the Gesture-Controlled 3D Interface Freespace (GCIF) are implemented to produce external and internal commands. The built hardware of the present invention include concave and convex mirror slices at the size, curvature(s), repetition, and locations so as to create the desired holograms/virtual images, optical real-object generation pieces (projectors, digital screens, other mediums as desired, etc.) placed to create the associated virtual images/holograms, sensor(s) for monitoring holographic-type spaces and reporting data, and the computer and software pieces/code used to analyze the collected data and execute further commands as directed

### BACKGROUND

This application is a continuation from provisional to non-provisional status; it is a continuation of the provisional application No. 61/754,960, having the same title. This invention relates to a holographic-type and image projection device and the fields of optics and computer sensor systems used with an array of mirror elements. This invention further relates to a method for allowing a user or independent party to interact freely with the hologram-type images in order to control computer systems, user interfaces, and/or complete tasks without the need of coming in contact with any physical surface. This work was completed during time at the University of Michigan-Flint, however, since all personal materials and effort was used the university has relinquished any claim to the invention as documented in the accompanying attachments (please see pdf document entitled “Legal_Ownership”). Additionally, the term “hologram” as used in the context of this document, is referring to an experiential descriptor and NOT to the technical definition of a hologram; the invention itself is reproducing images that will achieve a similar result for user interactions and thus the term is utilized only to aide in describing the visual layers of information created by the invention.

The possibility for computerized spaces to exist within the same volume as user-inhabitable spaces is the foundation of interest surrounding this invention. Having a background in spatial architectural design sets a precedent for work to be both intellectual and experiential. A strong curve toward that which is tangibly human-interactive in result is already a popular area of research for the field of computing, as well as a personal interest. The channels which allow human interaction and control of computers are now able to be combined with the electronics, and even used in built architectural spaces. Where the limits of these interests cross is the starting point for the present invention and the source of inspiration.

The present invention aims to examine the potential of certain gestural recognition capabilities as they may be combined with holographic-type display systems. The need and future of this type of technology is endless and at the very least will offer solutions for the disabled to better use computer systems and other devices. In particular as one example, this invention fulfills the need of those individuals who do not currently have the means to operate tiny computer keys and computer mice. It also offers a solution for disease control in the sense that an electronic command(s) can be executed with an interactive graphic visual AND without the need to physically touch anything; this means that there could be less surface-spread bacteria, etc.

In addition to fulfilling these current needs, the boundaries of the proposed type of interactive, holographic-type spaces are useful in transitioning the functionalities of current and future computer systems into a different type of control environment. Instead of moving towards the substantial, yet more common, research that currently works with gesture-recognition tailored for image manipulation or resizing, this project will utilize it in conjunction with holographic-type mediums for controlling any given electronic device. The layer of visual information the hologram or virtual image provides fulfills ergonometric and visual understanding which is not present in similar inventions.

This would eventually remove the restrictive need for keyboards, computer mice, and other computer hardware. The sequence of the phases of work used to achieve this goal include two major components—the 3D Holographic Freespace Control Unit (HFCU) used for typing characters for this project, and the Gesture-Controlled 3D Interface Freespace (GCIF) used for other functionalities. The present invention consists of both of these components, both in isolation and then incorporated together for the final result. The prototype of the current invention was created to provide a datum to which future versions can be compared and re-evaluated. Current gesture-recognition devices of this type and aptitude are not made in conjunction with holographic-type mediums, and do not work to remove the need for keyboards, computer mice, etc.; therefore, a new type of sensor-monitored, holographic-type control space (HFCU) is needed in the field.

### BRIEF SUMMARY OF THE INVENTION

The present invention is a 3-dimensional, sensor-monitored, holographic-type free-space and the control unit from which it is produced, as well all of the components needed to create a fully functioning interactive system. To achieve this, concave or convex mirror slices are arranged, often in parallel, in any number, direction, overlap, scale, distance, proximity, curved based on any mathematical equation, an/or creating the hologram or virtual image at any distance from the invention. The source of the hologram(s) or real object(s) are calibrated, along with the source hardware, projectors, screens, reflections, and any other elements necessary to adjust and create the virtual images relative to the user. The sensors of the chosen type(s) are placed to effectively process input and output of the data from the respective volume of space; this will, at times, be the same volumes of space in which the virtual images reside to trigger additional events and to create the interactive aspect of the present invention. Code and or applications will be developed and run to pass information, input, output, events, or data from the sensor(s) and connect the necessary sensors and other electronic devices as needed. Code and or applications (or the same code/application) will be developed and run to pass information, input, output, events, or data from the real-object generation source and any additional components. The necessary projectors, screens, and/or any other electronic devices are also connected as needed. The virtual-object/hologram generation source and components of the chosen type(s) are placed so the input and output of the rendered virtual images appear as desired in the designated volumes of space. The systems' components are then calibrated to function as desired when certain designated gestures are executed within the sensor-monitored spaces and/or holograms/virtual images.

The invention is called a SENSOR-MONITORED, 3D, INTERACTIVE HOLOGRAPHIC FREESPACE CONTROL UNIT (HFCU) and provides a holographic-type user interface that is operable via interactions with the holograms and/or sensor(s). The implemented prototype example is created via usage of a second opening from the one at which the holograms are produced, potentially used for video, alternating real objects, and/or any material to create the real object to reflect or a surface to project images onto: one prototype uses a translucent vellum to project images onto which in turn become the interactive hologram/virtual image. This uses sensor(s) or camera(s) placed to collect data, mostly via gesture recognition and depth changes. These can be one or many devices of any make; however, a depth sensor was used to create one prototype for the present invention. These sensors, at least in part, will be used to observe the same time and volume of space in which the hologram and/or virtual images reside, and will detect the select gestures or interactions causing additional events to trigger once the data is processed. This prototype includes all of the power cables, connectors, and adapters required to connect the various pieces of this invention together and also any of the items needed to implement the associated code. Another component of this invention is the associated code(s) that control(s) the input and output and execution of any event or media used to operate the components and/or overall system. The current prototype uses variations of several algorithmic processes, as shown in FIGS. 17-24. Finally, the holograms or virtual images in the volume(s) of space they occupy can be static, operable to be switched by the user, operable via voice commands, combined with voice commands, self changing/updated, or changed in real time or via video feed, or any combination thereof, or, can be implemented and utilized via any desired method.

### BRIEF DESCRIPTION OF THE DRAWINGS

FIG. 1 depicts the functionality of an existing facing-concave-mirror arrangement that can create virtual images; it shows both the aerial view sectional view of the concave mirrors. It also shows the real object, virtual object, and path of the ray tracing that produces the virtual image, or hologram, for reference purposes when considering the present invention, shown starting in FIG. 3.

FIG. 2 illustrates the existing Microsoft Vermeer usage, with 3D Holographic-type video feed, however, with the same limitations, and use of the full 360 degrees of mirrors, a limitation for the present invention.

FIG. 3 illustrates with strikethroughs the sections of the mirrors that can be omitted for still viewing the virtual images along a selected axis as seen at 9. The bouncing light rays now occur at the remaining angles (direction of arrow(s)); this occurs along the same axis as the line of sight.

FIG. 4 presents the remaining slices of mirrors which function along the same line of sight depicted in FIG. 3; this is the necessary section of the facing-concave-mirrors which will still produce the visible virtual image above the real image, at this perpendicular angle; an array of the slices is now an option. These remaining concave or convex mirror slice example used in one instance of the present invention; these slices can be used singly or in multiples, but is shown as an array for the purposes of demonstrating one type of example construction. This shows one type of opening through which the virtual image will appear

FIG. 5 shows a minimal example of an array of these slices and how it can create a series of holographic-type controlling mechanisms; this shows a sectional array of mirrored slices yielding one example of the array of virtual images/holograms. This figure indicates the slices can continue in any number, direction, overlap, scale, distance, proximity, curved based on any mathematical equation, an/or creating the hologram or virtual images at any distance from the invention.

FIG. 6 presents a view of the openings could be altered for aesthetics as seen as the aerial view of this device.

FIG. 7 illustrates the series of holographic-type controlling mechanisms combined with one example of a sensor; it can now use these proximity sensors and the retrieved data reports to trigger other events. The sensor(s) can be used to gather data about interactions and/or changes with the holograms/virtual images—this position depicts only one example of a sensor location which can be used to gather data in the present invention; this could also be one or multiple sensors of the same or varying types and processing, using the shown line of view of the sensor or can be altered or expanded to gathered from any desired volume of space.

FIG. 8 presents an aerial view of that which is seen in FIG. 7.

FIG. 9 shows one potential use of protective layer; clear one-way glass in this example still allows hologram/virtual-image visibility as well as being a protective layer. This barrier can also be made out of other materials, such as glass, colored materials, plastic, one-way glass, etc. and may or may not be assisting the security of parts below or inside the device.

FIG. 10 presents an alternate option and position for FIG. 9.

FIG. 11 presents the initial invention goal of the holographic-type control unit prototype. Pictures representing themselves or even single pixels can be placed similar to the way the video feed is swapped in and out as needed or at the rate needed for the desired effect. This example is showing 4 sets of concave mirrors (same range of possibilities as in 18), with opening on the bottom, yielding possibly of a changing array of holograms/virtual images.

FIG. 12 presents Current project goal of the holographic-type control unit. Pictures representing themselves or even single pixels can be swapped in and out at any rate, for example. The source of the real objects with respect to the curved mirrors will be projections of various pixel images captured onto an angled surface or plane, as the implemented example used to demonstrate the function of this device; however other arrangements are also possible. For the purposes of the present invention's prototype, these will represent a selection of actual ascii characters to be passed to an API to achieve in-air typing and the virtual image will be what is produced in the field of interactive, sensorized, holographic-type space. An example creation at the real object location can be seen at 35, made from computerized screen at the desired dimensions to fit the control unit—the real object can be created multiple ways, or as in 36. Another example creation of the real object location can be seen at 36, made from the projecting or reflecting the images onto the location of the real object, causing the holograms/virtual images in the sensorized space 37.

FIG. 13 presents a possible future iteration of this invention to be tested if/when specific parabolic mirror slices at a given/adjustable parabolic equation are available. This gives an example of where this particular object's virtual image would converge, with potentially better results in terms of a freestanding hologram/virtual image. It shows an example sensorized space, or any defined volume from which to measure with sensors; one point of intersection of the concave or convex mirror slices; an example arrangement showing alternate mirror curvature which when calculated allows the virtual image/hologram to be at a given distance and size above/outside the mirrors/control unit; this control unit can still either be done with or without opening/projections from an alternate location; alternate locations and generations of the real object needed can be from the static locations, but also from the bottom, side and/or any location(s) inside or outside of the present invention; the size, scale, width, openings, and equations used to generate the curvature of the concave or convex mirror slices will vary depending on the desired projected image and may or may not intersect at the same points or symmetries, for example the intersection of the mirror slices can be seen at one of the points labeled 38; an option for mapping the sensorized, holographic-type space for alternate functions on screen and off; examples of alternate options for the location and/or position for sensors to detect data at 41 and 42; also the overall system components shown would include device(s) and/or containers to secure the unit; any appropriate size, shape, or materials can be used.

FIG. 14 presents the potential variation of the present invention where it would include a single screen combined with that of the holographic-type controller/input system/device. This view is only of a partial array of the present invention/holographic-type control unit; this represents any and all types of holographic-type production embodied in this application as well as single or multiple instances of these inventions used either singly, in multiples, individually, as separate entities, or in any combination with those parameters described in this application or any figure included.

FIG. 15 presents one alternate variation of FIG. 14 using a multiple screen example combined with holographic-type controller/input system(s).

FIG. 16 presents an alternate variation of FIG. 14 or FIG. 15 giving the option of a multiple screen example combined with multiple holographic-type controller/input system while freeing the space around a user(s). A potential usage and application of the holographic-type control unit, with multiple screens controlled by the gestures measured in the holograms; can also be extended or scaled for rooms, buildings, etc., all controlled by or containing the present invention (holographic-type control unit). This is an example of the potential of using single or multiple units of the present invention; they can be constructed as one or many different units, function for different results, all be of different size, shape, type, or combinations thereof; in this example, the present invention is demonstrating an arrangement of a holographic-type keyboard or computer interface(s).

FIG. 17 presents an example schematic of the system which uses the static virtual image version of the present invention for computer control.

FIG. 18 presents an example schematic of the system which uses the transient virtual image version of the present invention for computer control

FIG. 19 presents an example schematic of the system which uses the transient hologram/virtual image version of the present invention for computer control with the added function of the possibilities of 46 and this includes a sensor-monitored gesture recognition space though which interactions can happen with and without the holograms/virtual images; there is also a potential second sensorized space for different types of gesture control and/or holograms/virtual images, however, there can be any number of these defined spaces.

FIG. 20 presents a possible algorithm map for the device control with Static Holographic-type Imaging-better for keyboard-type uses; example process 56 is used to make one type of prototype of the present invention code.

FIG. 21 represents the algorithm map for the device control with changing holographic-type imaging—in this case the example is using binary or proximity type sensors with specific controls needed for normalized interactions instead of video feed; example process 57 is used to make one type of prototype of the present invention code.

FIG. 22 explains an algorithm for using a depth sensor/screen display monitored with hand gestures; two simultaneous loops are used in example process 58 and used to make one type of prototype of the present invention code.

FIG. 23 presents an example algorithm for using a depth sensor/screen display for a combined system; example process 59 is used to make one type of prototype of the present invention code.

FIG. 24 explains an algorithm process/flow chart for using a depth sensor/screen display monitored with hand gestures AND the holographic-type controller; simultaneous loops are used in example process 60 and used to make one type of prototype of the present invention code.

### DETAILED DESCRIPTION AND BEST MODE OF IMPLEMENTATION

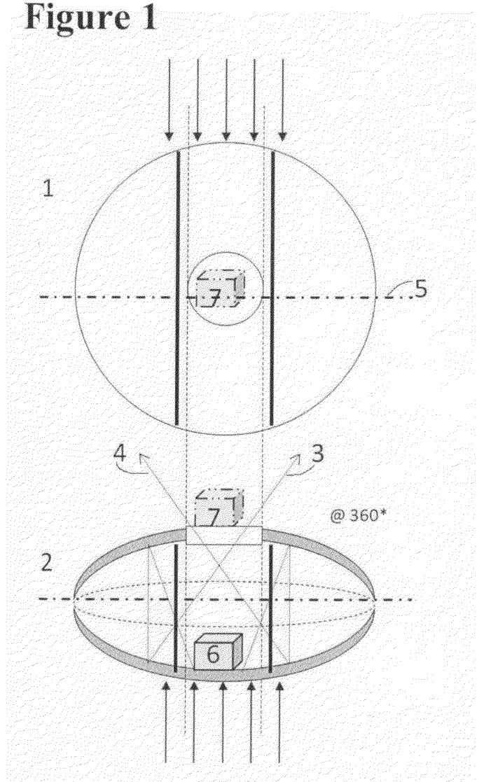

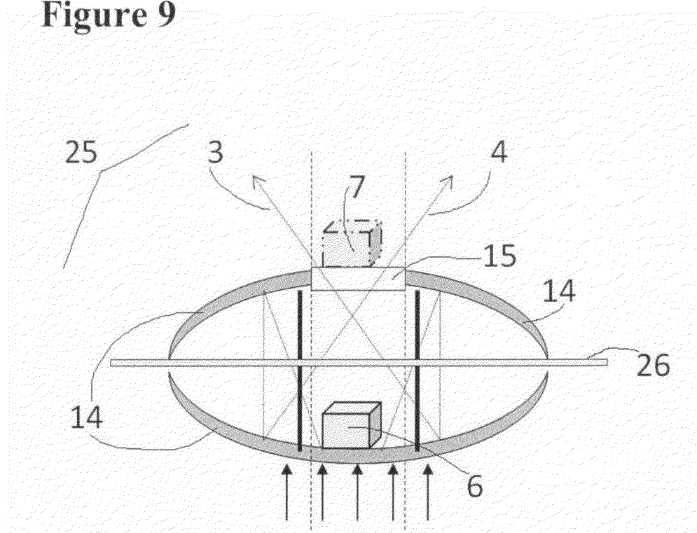

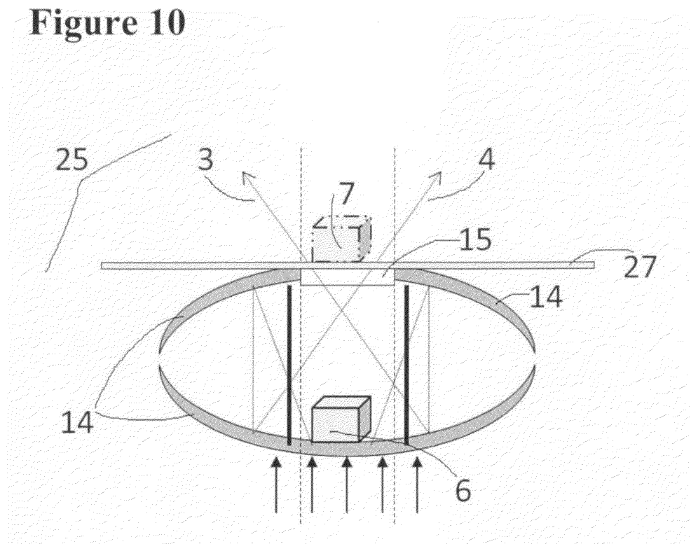

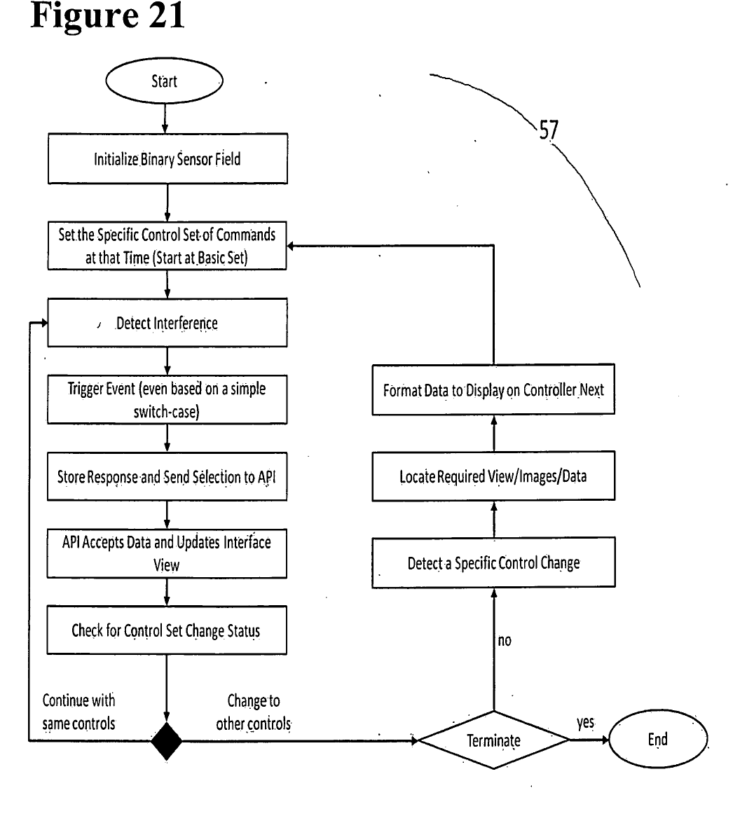

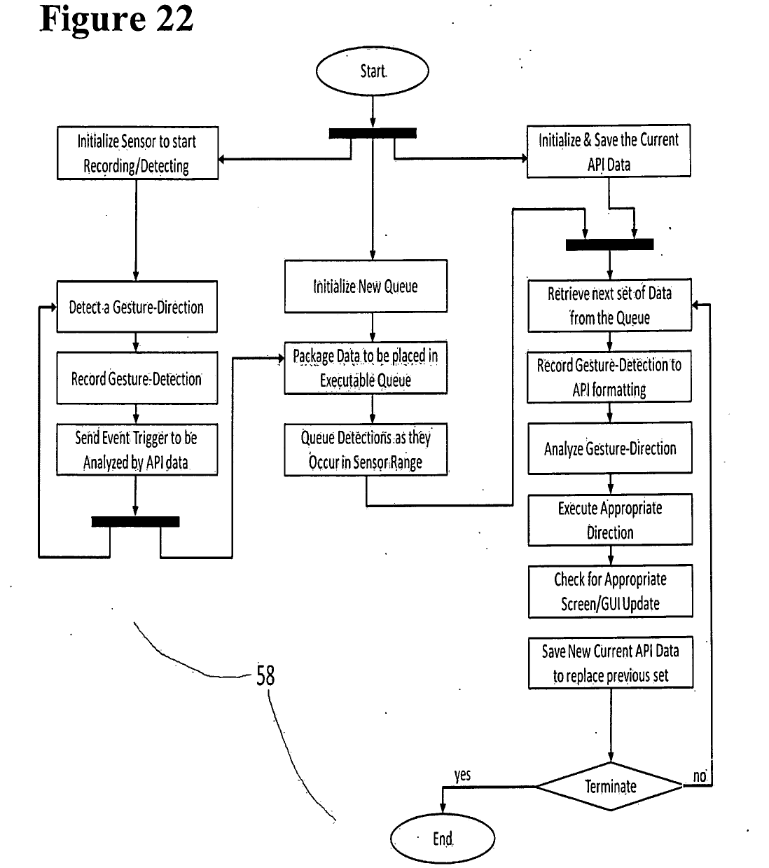

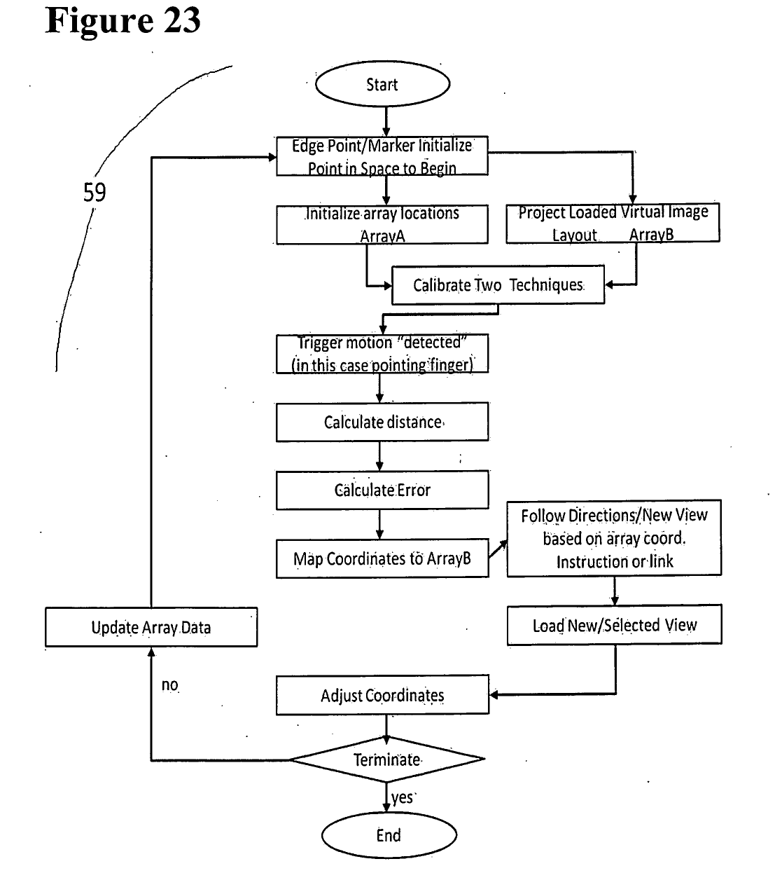

The following will give a detailed explanation of the ways in which the present invention functions and is setup. Any variation presented of explained in the FIGS. 1-24, or explained in any claim or part of this application are also relevant forms and/or functions of the present invention; however, the following discussion is limited as follows to omit redundancy. The following bold-text items represent and are defined as some of the terms which are used in the discussion that follows:

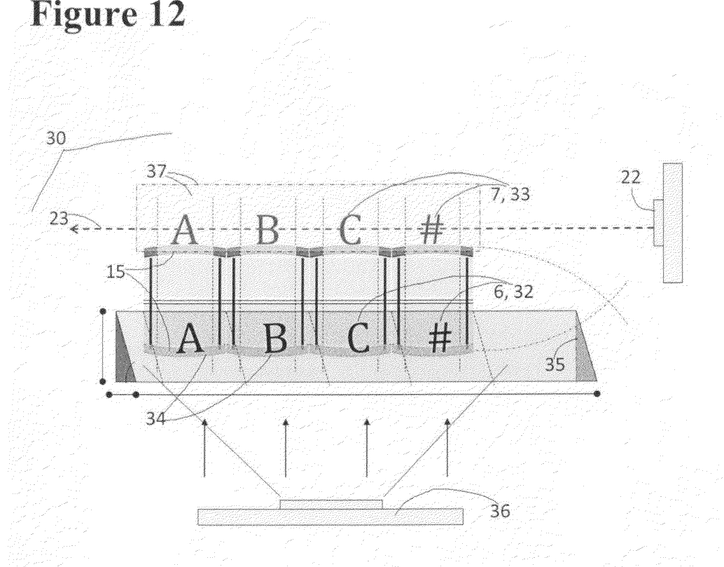

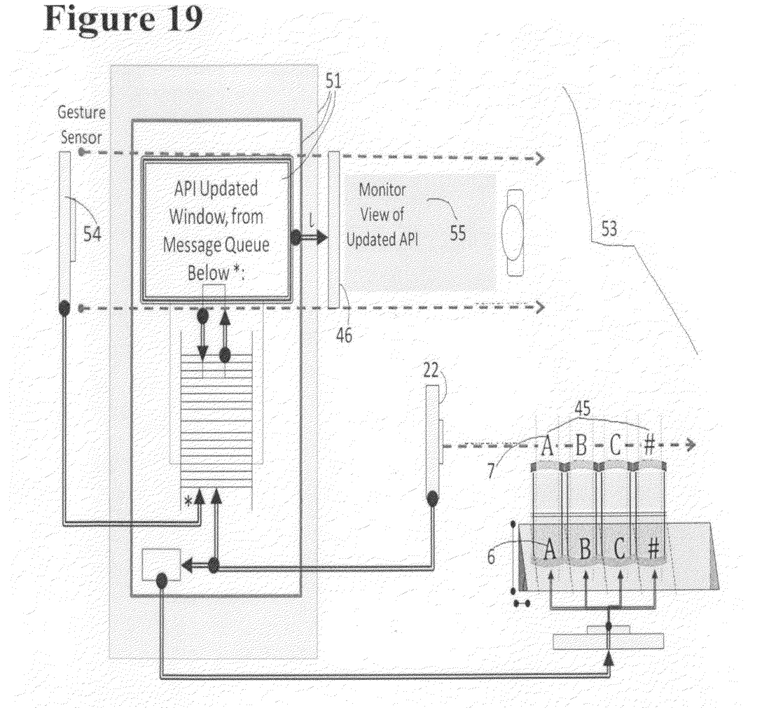

3D Holographic Freespace Control Unit: (HFCU or Holographic Control Device)—This will be the device created and used for typing characters for this example prototype in place of a traditional keyboard. This device is inclusive of one of sensors that are programmed to detect linear distance to a given object. This device takes in data and brings up a correct, associated image and consists of an array of linearly adjoining slices of concave mirrored surfaces with opening at the top and bottom for the manipulation of virtual, holographic-type imagery. At this time, the term HFCU refers to the device regardless of the total number of slices used in the array, position, overlap, etc. The code in this example usage reacts to a set of swapping arrays before it is combined with and/or connected to the API/GUI data of a basic Windows system. This component is depicted in FIGS. 12 and 19.

Component (as used in this project): Generally, the term component refers to the respective device or set of devices made up of the individual parts relevant to that point in the discussion. For example, the 3D Holographic-type Freespace Control Unit (HFCU) is considered a component in its own right, just as the Gesture-Controlled 3D Interface Freespace (GCIF) is also considered a component in its own right.

Freespace: This is the term used to describe the volume of physical space that the user will create motions within to control aspects of the API. This space is characterized to have the quality of being “free” due to the fact that the space is literally open, without obstructions or hardware interferences. The user interacts with this space as freely as any other open space, but it is a special type of open volume in that it is being monitored by sensors which will determine what API command to execute when there is interaction between the human user and this volume of space.

Gesture-Controlled 3D Interface Freespace: (GCIF)—This will be the volume of space and hardware used for additional functionality such as motions analogous to a computer mouse click, selectors, re-sizing, etc. It includes the established connections between the computer screen and human movements, as well as the volume of open space in between the two (it takes advantage of existing gesture recognition algorithms due to time constraints). This is also a component used to manipulate the API window in question. It includes a sensor, user screen/window view, and the physical volume of space to be monitored by the sensor. After this work is completed with one screen, the setup can be applied and tested with multiple screens creating a visually-defined, user-occupyable space; at this point, the term will apply to the original elements as well as the additional screens/monitors and volumetric space within the sensor field. This component is depicted in FIGS. 12 and 19.

Sensorized Space or Sensor-Monitored Space/Volume: This refers to a certain classification of volumetric space that is measurable via the sensor type employed for a given device. The computerized sensor, a proximity sensor in the case of the present invention, is the constraint determining the exact dimensions of this type of spatial volume. The attribute of this defined space that consists of the width, length, and height that the given sensor is able to capture in turn determines the volume of space in which human gestural interactions can be introduced. The volume that is defined by dimensions is also a space for actions to be recorded and interpreted. This double function of one volume of physical space is referred to as “sensorized,” and it is a key ability utilized and explored in one prototype example.

Touchability: If a physical object is touchable, it is has the attribute of allowing one to come in contact with and perceive it, often with the hand, finger, or some similar entity. The definition of the word implies that some sort of physical contact is established. Touch is how we currently communicate command to a computer system, either by the mouse, keyboard, or even by voice in some applications. While the point of the present invention is to produce this control through open space without needing to exert this physical touch, the idea and mental connection associated with touch is preserved. Keeping this abstract notion of a touch producing some effect for a computer screen, but eliminating the actual physical contact traditionally needed to manipulate or read gestures into a sensor system, will be the composite quality referred to as “touchability.”

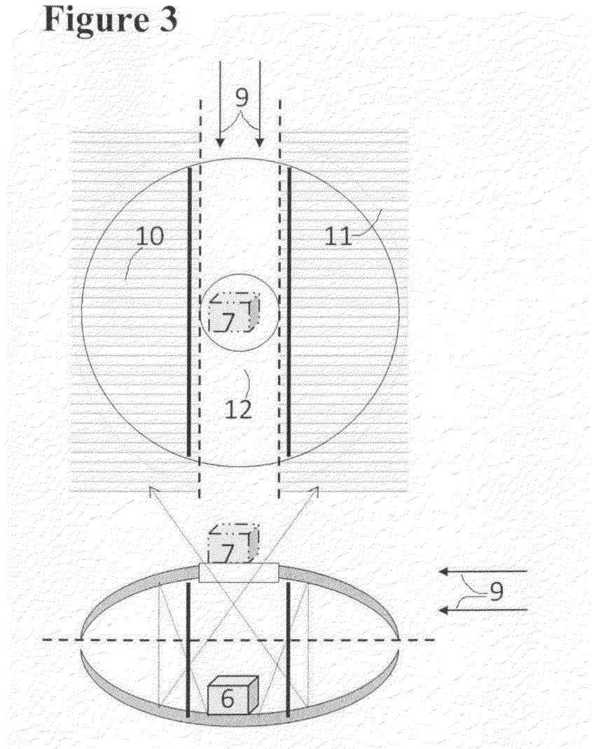

The first component of the present invention to be constructed and implemented is called the 3D Holographic-type Freespace Control Unit. The holograms/virtual images require the intricate addition of carefully calculated and overlaid imagery. The goal of this part of the project is to create a device occupied by the hologram/virtual images; this is the same field of points in space that the invisible sensor field will constantly observe for changes to record and act upon. The composition of the unit started with a study and understanding of the facing-concave-mirrors in its most basic, parabolic state as seen in FIG. 1. This figure depicts the general function of the facing-concave-mirrors. The view shown from the aerial position, FIG. 3, illustrates the circular shape of the mirror when viewed from this direction. This is formed from two parabolic mirrors stacked on top of each other, with the concave surfaces both facing inward and being that of the mirrored material. The points 3 and 4 show how the light ray would normally be traced, and this is what exists within the device occurring at the complete 360 degrees. The light rays 3 and 4 reflect from the real object 6 placed at the bottom to any given point on the upper concave mirror, bounce off the concave mirror at a congruent angle, and the process is repeated when the light ray reaches the bottom mirror. At this point, all of the 360* of reflected light rays intersect, effectually reconstructing the now visible, virtual image 7 through the opening in the opposite mirror. This is what the user would view to be the holographic-type mirage 7; this appears to the human eye to be the real image even though it is only a virtual image created from the light bouncing off the original real object from every point of its surface area. The bottom part of the diagram FIG. 3 shows how these components exist given the parabolic curve that places the center of one mirror exactly at the focal point of its opposite. Of course, this is showing only one instance of the light rays in the sectional view taken from the dashed line in the corresponding aerial view, 12.

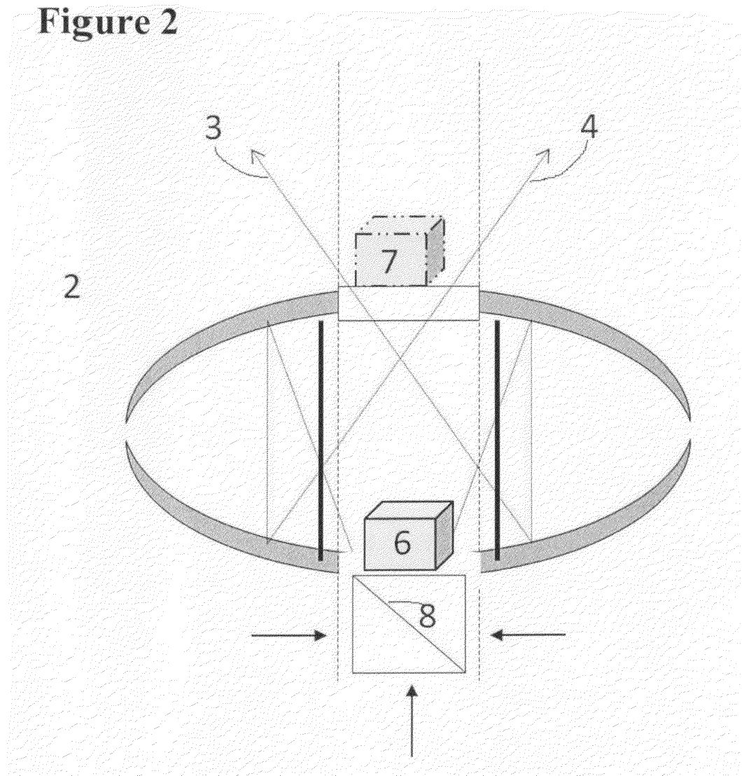

One addition made to this configuration of mirrors was captured by the Microsoft Vermeer; it chose to keep this mirror placement but with a second opening where the original real object was located as seen in FIG. 2. Hardware was constructed to hold the selected object (or reflected video feed, in this case); now, the object could be exchanged for another at any time, unrealized to the user above viewing the virtual image. They constructed this device out of scaled up mirrors and chose to use a 3D video feed projected into the bottom of the facing-concave-mirror(s) 8. The user can view this as a 3D moving hologram/virtual image above, at the opposite mirror's opening. This thesis will not utilize a device this way for a variety of reasons, but it will work with an example set of approximately 5-10 slices of them, improving the existing setup by utilizing the idea of a second bottom opening for a revolving projection of the selected set of controls or keyboard keys (as in one example prototype) at a given time. It will be constructed in a different way and for a different result and essentially for different situations, FIGS. 3-24.

The present invention takes a strong interest in the fact that when a user is viewing a virtual image created by combinations of concave mirrors, they are doing so only from a single line of sight 9. There is no need for a single user to have a 360* view in this invention, apart from personal preference. For example, only viewing a laptop computer from a single line of sight is not viewed as a problem, it is simply all that is required for general use. Separating this desire from the current circular device may also provide alternate advantages for a holographic-type display which this invention provides. If the same aerial and sectional views of a typical facing-concave-mirrors are considered as in FIG. 3, then also consider the portions of the mirrors that are unnecessary 10 and 11 for viewing the hologram/virtual images, from the direction depicted by the arrows 9 The interesting option comes from the section of this device that is left if the two shaded sections 10 and 11 are literally removed. When gone, the remaining slice(s) 12 and 13 will still produce a usable virtual image for the present invention, along the two-directional axis indicated by 9. This is the only section that is absolutely necessary due to the fact that the ray tracing still exists within the remaining slice, in other words, along the same axis the user will view the hologram/virtual image 9. At this point, there is a usable hologram/virtual image created from hardware that also has a linear edge or quality to it, and this provides further options for usage.

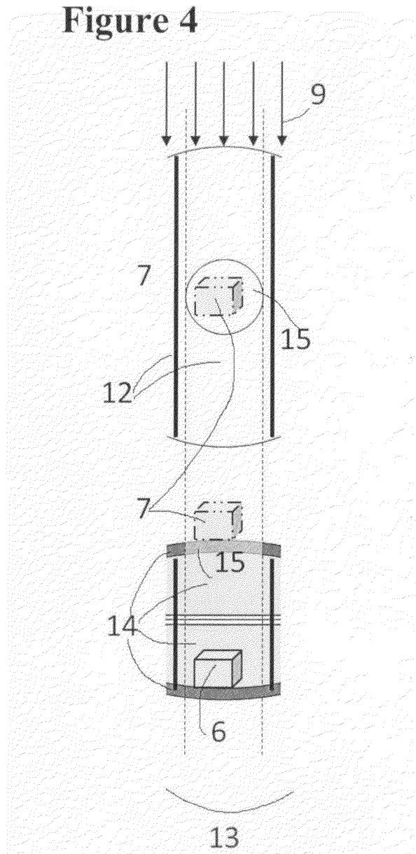

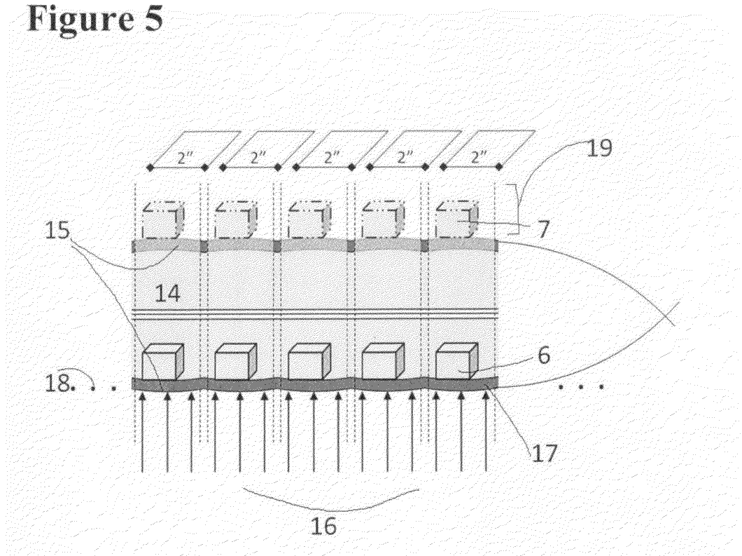

Given this slice of the concave mirrors, FIG. 5, it is now possible to create an array of slices aligned next to each other in a row and use them to produce a variety of virtual images at once, one example of one type of arrangement is seen in FIGS. 4-24. For example application of the invention, this could provide the holographic-type controls necessary to create the effectual holographic-type counterpart of the in-air typing project, as one prototype has implemented. In this example, there exists the same orientation 16 as the single slice and is referenced by the arrows 9 in the diagrams. There is the option of total number of slices used for this device; this example implementation will start with three slices in a row and add additional functionality as time allows, but is inclusive but not limited to the combinations of arrangements as described in any part of this application, or as described below or shown in any figure. The array of holographic-type images can be as small or as large as is feasible but for this example will all exist within the space the sensors can retrieve information from to transfer into other programmatic events. The ends can be resolved physically in a number of ways, from abruptly stopping with a single plane to finishing it off with the parabolic concave mirrors that would complete that portion of the traditional facing-concave-mirrors as though it had not been sliced and re-arranged on that one, particular side. In terms of this example, the largest concave mirrors used for this assembly were tested by July, 2012, were 9″ in diameter, allowed a 2″ aperture, and up to a 2″ potential virtual image width, FIG. 5. This allows more than enough volumetric area to facilitate the motions that will replace typing with computer keys, at least for the scope of this single example use implementation and arrangement of the present invention.

After the mirrors are assembled, slight alterations 15, 21, 26, 27, etc., can be made for better presentation at a later date. The virtual images exist in what can be called a holographic-type space and this is in part defining where and how the sensors are applied and secured for the illusion of the interactive holographic-type controls. The openings in the hardware that allow the virtual images to converge are circular by default in this scenario, but can be reshaped for convenience or aesthetics, etc.

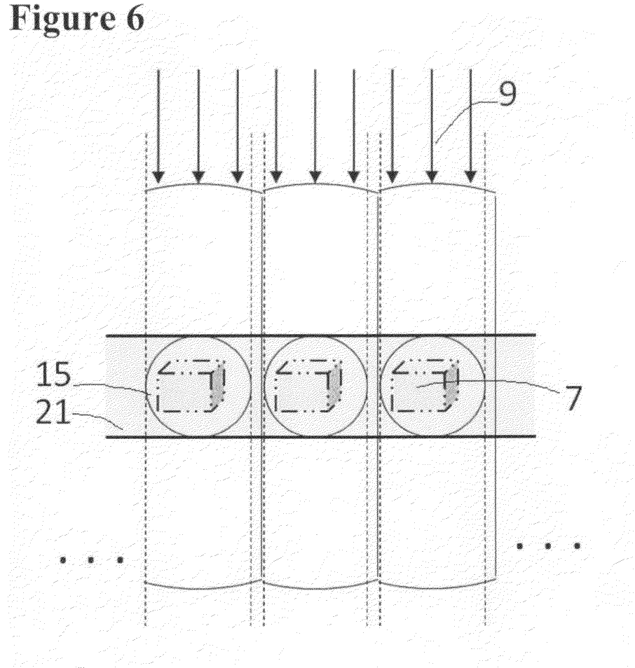

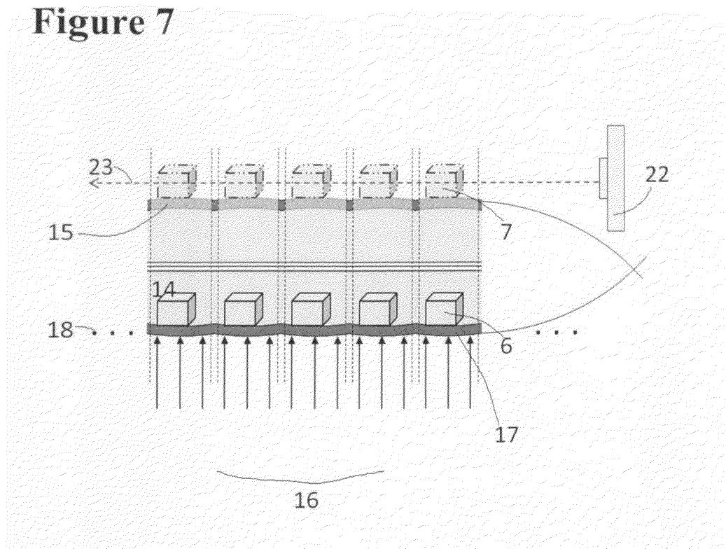

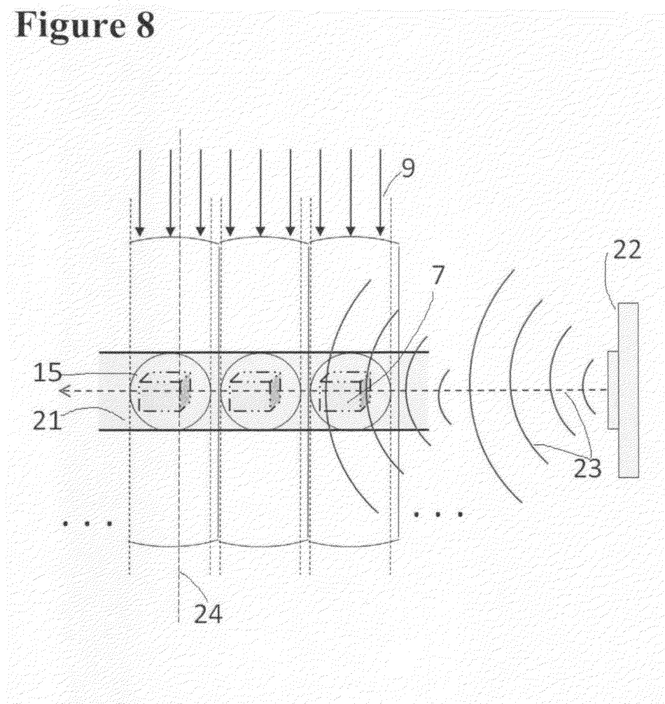

A series of sensors or a selection of one sensor will be programmed to gather data from a static or dynamic angle(s) 22. The diagram 16 represents a possible arrangement six mirrored slices and of the corresponding sensor(s). The arrangement and sensor in this single example will need to be set and secured to observe the same area that the holograms/virtual images will occupy 23; they will advantageously interfere with each other 23 and 7. This will produce an example situation of the present invention where the user views him/herself touching the holograms/virtual images to control an associated API command; but, in actuality, the change in the sensorized, holographic-type space is being recorded by the sensor algorithm and linked to events in the API, but, again, this is one application and function that the present invention could produce, and only seen here in one of many arrangements and/or quantity. The virtual images used can be any static image desired in this scenario; they can effectually be treated as independent images, objects, or even single pixels within the limits of size determined by the mirror shape used. Consider the same sensor as illustrated in the sectional view [FIG. 6], but as seen in the reduced array of three slices depicted in aerial view shown in FIG. 8. This is assuming the sensor in the previous FIG. 7 is the same sensor viewed at a different angle in FIG. 8. This diagram illustrates how the sensor is observing a larger volumetric area than just a simple straight line 23. This will be useful in the circumstances where allowing for variances in finger or selector placement. Selector here is referring to whatever object will be placed into the sensorized field of space, the same way a mouse cursor is placed on a hyperlink to select it or finger is used to press a letter or numbered key on a traditional keyboard. Again, this diagram is referring to the array of mirror slices, their holographic-type virtual images only viewable along the axis depicted by the direction of the arrows 9.

Upon working connection of this single example of the invention to the Windows API (or a simpler mock version of an API created to demonstrate this project's capabilities) and working completion of the interactive holographic-type functionality, additional protection of the systems could be achieved with a solid, clear, up to ˜100% transmittance or vellum barrier 26 and/or 27 inserted along the center axis of the hardware 25. These are some of the possible variations described and only in a few of the possible materials available; substitutions may be made as needed or desired. It will both protect the mirrors and still allow passage of the light to create the holograms/virtual images necessary for the user's interference or interactions. To achieve a more concealed version of the hardware, barrier(s) 27 could also be placed along the top, above the aperture and parallel to the row of real objects below, depending on the desired effect. As one possible alternative, applying the barrier along the top with one-directional glass is an experiment of interest as soon as the material is available. This in a specific circumstance could create the same functional tabletop effect that the Microsoft Vermeer created. However, the Vermeer allowed the aperture to be an opening in the table whereas the second of the solutions that this invention provides would allow no opening in the protective barrier 27.

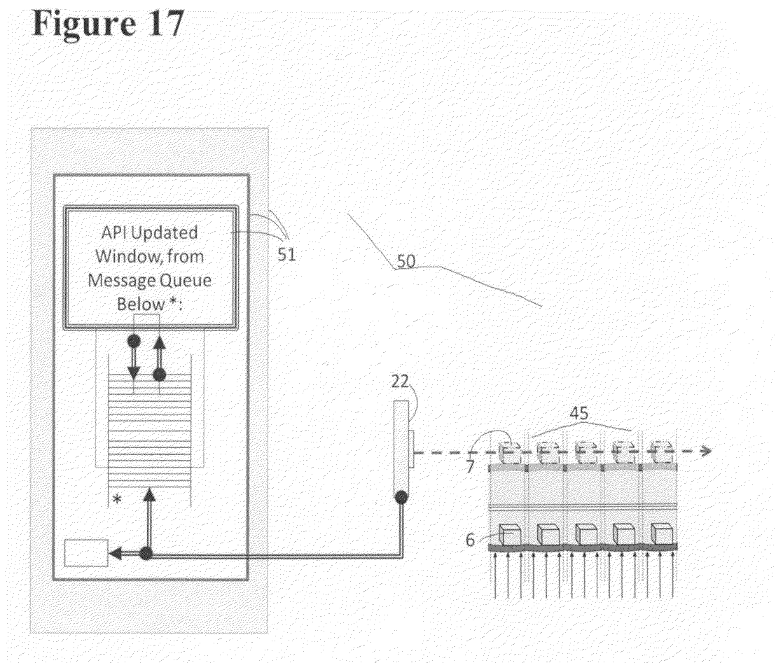

When data is ready to be collected so that a certain control can be established for this example, programming will consist of certain relationships that will be assigned and communicated between the input and API framework as in FIG. 17. One variation is considered using a basic algorithmic approach is considered for this static situation in which the holographic-type display will only portray a static set of images. In this example there can be several sections of the programming that will be necessary to complete the overall schematic; at this point, two main flows of data are required. In one section there is the need to record the sensorized data, evaluate it, and send it to the API structure for processing 51 and updating the user screen. The other is the structure of the API that will use a message queue and windows to receive and execute the events as directed. The system will use interrupts to process event data and to control the API 51 on the main computer system housing the code. There will need to be a communication protocol in this example that is applied to the separate elements of the schematic so that data can be passes back and forth between the program(s).

In one of its simplest forms, this can be achieved with an algorithmic approach that will work using a continuous loop in which queued selections are executed as they are made by the user. The overall code itself will be written for CPU execution to begin with and translated for GPU execution as appropriate or as time allows. To begin the code, the sensors themselves need to be initialized with checks for proper working order along with the initial set of holographic-type visuals that are available. The sensors will determine a normalized state from which to compare to each consecutive state measured at a certain repetitive and continuous amount of time thereafter. If a change is detected by comparison in this particular example, then an event-triggered switch case will be accessed and certain course of action can be taken to communicate with the API program—or another part of the API program, if necessary. The portion of code controlling what is seen through the API in this example accepts the directions and updates the user screen appropriately. At this point, in this example, the program will check the message queue for additional changes, determine if it is necessary to continue, and repeat this process until the user signals to quit. The overall API structure would focus on a main continuous loop that accepts data and directions from the sensor program as it determines each course of action to be executed, as in FIG. 17.

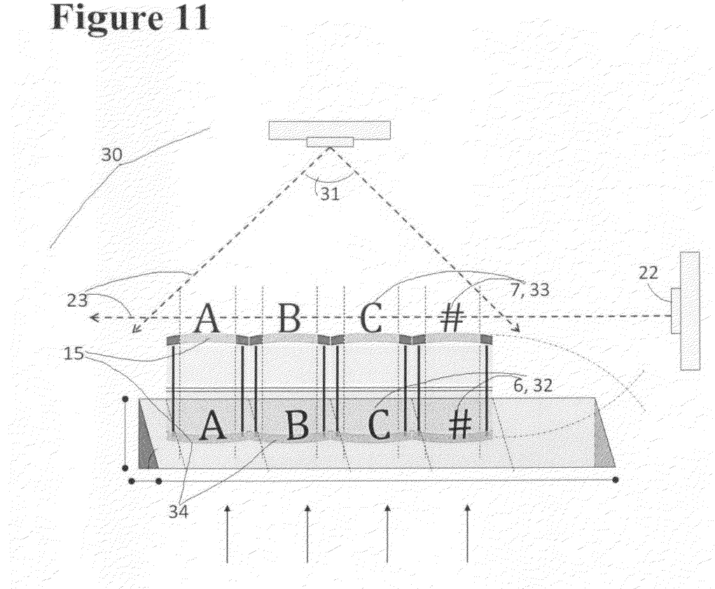

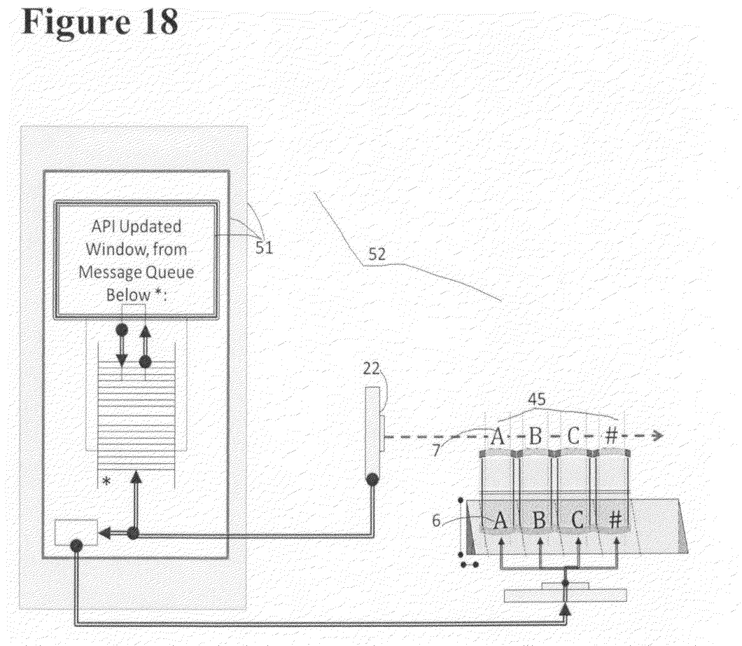

After the static holographic-type display is achieved, a variation is demonstrated where the process can be applied to create a changing holographic-type display as in FIGS. 11, 12, 18, and/or 19. This step beyond employing the static set of holographic-type images would consist of configuring a method for changing out or swapping one set of controls for another or even using one or multiple video sources. This will be a goal for this control device. However, this variation will utilize a series of bottom openings for swapping various static images or video(s) instead of a single instance of 3D video feed. This is a different outcome, but instead now allows for the array to more easily function as in this example of individual letter keys; but, the options for use certainly do not stop here as in FIGS. 1-24. The device sensor will remain as described before, observing a certain field of space 31 that will be the same space as the virtual image projections. If the same aperture is mimicked on the both of the opposing concave mirror slices, then alternate images can be applied to the space where the real object must exist in order to appear as the intended virtual image. If the real image is placed onto an angled plane 34, 35 in this example implementation, then projections 36 can be applied to that plane but can be a series of these planes and projections/reflections in the present invention. The images used for the projections in this example variation, however, will be individual pixel images, called at will by the user interacting with the holograms/virtual images they produce 7, 33 instead of keystrokes on a traditional keyboard-again, this is only one of many applications the present invention allows. This leaves the method used to signal a switch in holographic-type keys as desired. The chosen approach in this one implementation is to handle this situation by leaving one mirror slice, that is, one holographic-type image, to be used as a switch key, seen in FIG. 12. For this example, when this image is interfered or interacted with, the signal sent from the sensor to the sensor program will execute on a separate loop that will control projector output as in FIGS. 18 and/or 19. This output for this example will consist of the most recently selected series of images, from the associated resource folder. The holographic-type display 45 will then be updated before the user as the new view of the natural user interface 55, and the selection of holographic-type keys can continue, and continue to be passed to the API program for processing. Again, this example will be implemented as a subset of keystrokes, but a larger range and/or configuration and/or number of holograms/virtual images can be set up in other variations of the present invention.

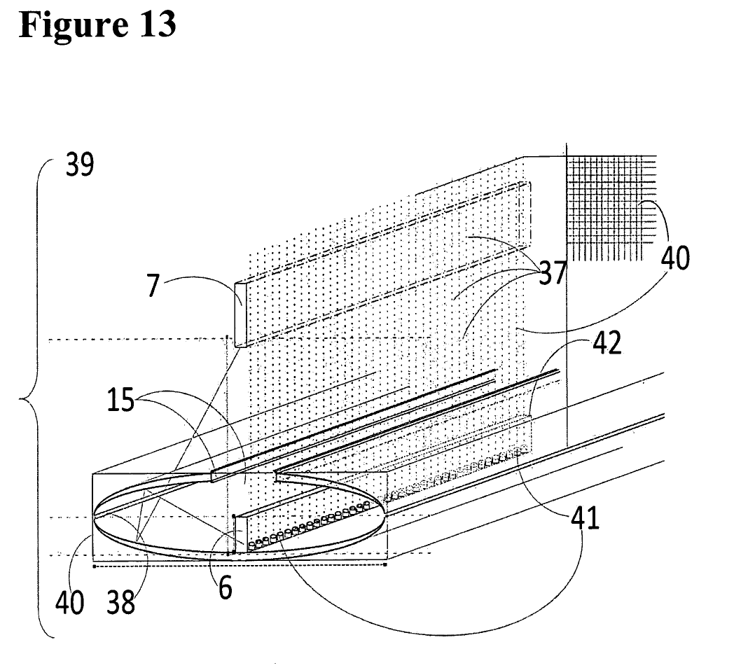

As an additional variation of the present invention, and according to the mathematical equations best demonstrated by the examples illustrated at http://mathdl.maa.org/mathDL/23/?pa=content&sa=viewDocument&nodeId=3595&pf=1, the parabolic curves of the slices of mirror used can be altered to specifically place the virtual image at some distance above the concave or convex mirrors. One example 39 of how/where the virtual image 7 could potentially exist larger, further away from the device in question, and/or conveniently distorted, as demonstrated in the FIG. 13. The idea is presented as one possible path of many for future iterations of the present invention. The selection of parabolic curves and the specific arcs chosen are abstracted in the illustration presented, but they show one combination which examines this idea and the possibilities these slices embody and these slices can be used singly or in multiples, but is shown as an array for the purposes of demonstrating one type of example construction, can continue in any number, direction, overlap, scale, distance, proximity, curved based on any mathematical equation, an/or creating the hologram/virtual image at any distance from the invention, and with any combination of real-object generation 6 component(s) and/or sensor(s) and/or sensor-monitored volumetric spaces 37, 40.

Given the original schematic, FIG. 17, as a starting point, there will now need to be some additions to accommodate the control device with the ability to swap elements, or “images” in this example, in and out on demand. In addition to what there was before, there is now the option for an extra loop that would accept the user input and check it for a certain value or tag an execute events. Depending on the result, the loop sends a message to the code controlling the projected images and performs checks to evaluate which action should be taken or which new images should be displayed via the holograms/virtual images at a given time, as in FIG. 18. After a decision is made, the data in this example can be passed to control the current image output until a new command is tracked via the control device sensor, as in FIG. 18.

As stated above, the images in this example of the present invention will be swapped in and out of the concave mirror slices as opposed to using a video feed or other valid methods; video feed can be used as well as voice recognition or other means with the present invention, but the swapping images used in this example of the present invention give a level of control necessary for this variation of the application that would not exist with other methods in this example application. To include this functionality, one algorithm can work based on the continuous loop as seen before, but it can include an additional branch and loop as seen in FIG. 19, 53, that is responsible for updating the holographic-type display when the switch key is selected; and, it will also continue on to wait for further directions. Only one of the switch keys is shown in this example and is controlled through a hologram/virtual image, but these can also be in many combinations, locations, types, etc., as well as controlled via other means for the overall system. This may be written with any programming language; however, C++was used for reasons of familiarity as well as for transitional purposes into parallel processing versions of the present invention and/or system components.

The other component to be implemented as a variation on the system function is the Gesture-Controlled 3D Interface Freespace, also referred to as a 3D occupyable space. Basically, it allows alternative operations and gestures that are useful, in this example it is used when a user interacts with a traditional API, creating a more ergonometric NUI. The arrangement of the 3D occupyable space is the result of the placement of certain hardware and/or sensor(s) that can operate as a second part of the system(s). In the simplest form, a single sensor 22 and/or 54 and/or additional sensors at any advantageous location can be used to map the effective, sensorized space 7, 19, 33, 37, 40, and/or 45.

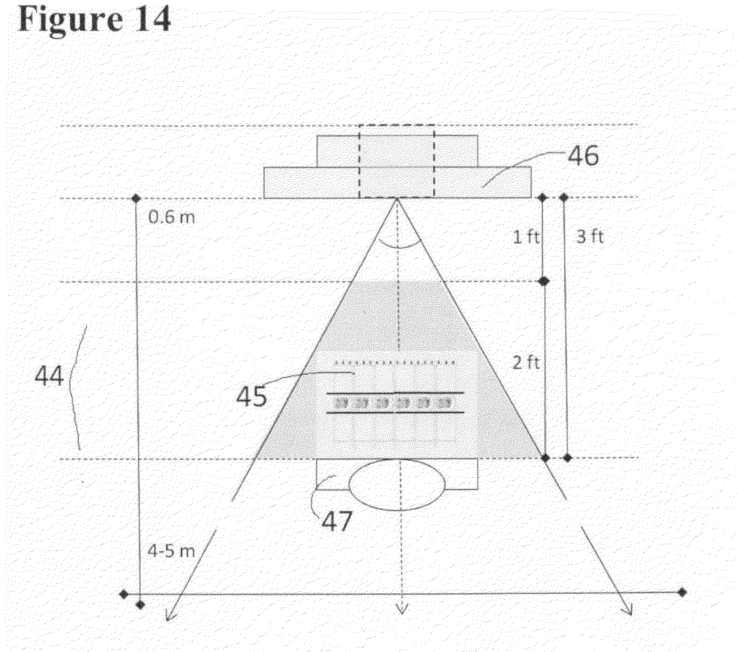

The sensor and the space it is capable of observing will be considered as one entity for the purposes of this discussion and example application. The space existing between the physical computer monitor used to view the state of the API in question and the human user 47, is literally perceived as a volume of physically empty space. However, this will be considered the second entity of this arrangement and example. Again the two types of spaces are overlaid, so that these two spaces are each functioning independently, but existing in the same points in space. This example application produces the effect of a human with the ability to control a computer API by interacting with this version of a 3D field of sensorized space of holograms/virtual images, as seen in FIGS. 14, 15, and 16; this is similar to the combinational method used to create this effect with holograms/virtual images in the control device described previously.

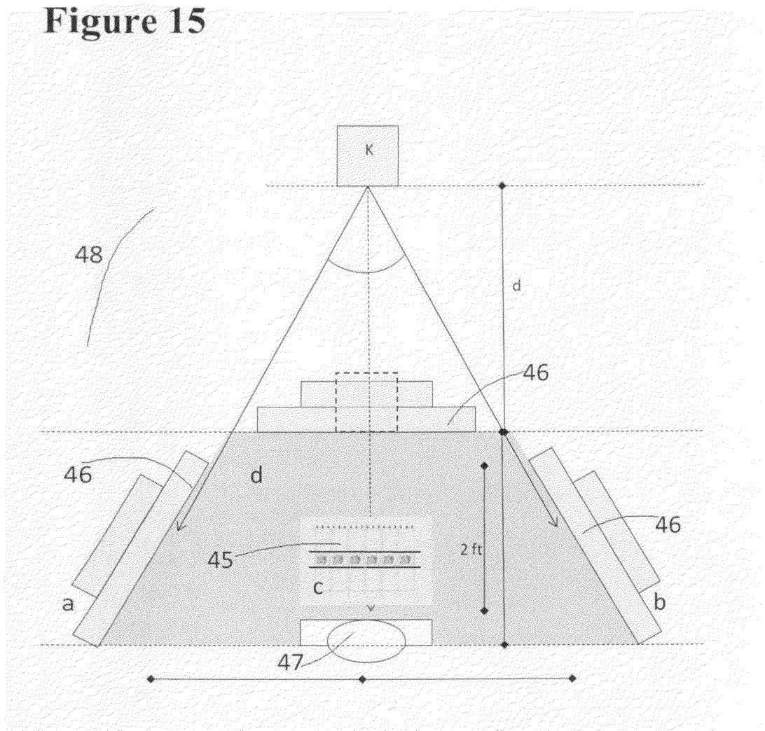

In the present invention, there are certain arrangements that could maximize the volume of sensorized space for a user. One of these arrangements is chosen to be used for one prototype uses the range of the sensor as the bounds for the volume in question 44 (that is, depending on the version and lens of the sensor(s) used) and can, for example, be placed behind the screen in question so as to take advantage of the lens angle by using a proportional field of space in which every gesture will be detected as seen in FIGS. 14, 15, and/or 16. This is, of course, assuming that a given gesture or command has been connected to an API control. It will be constructed and programmed for one screen, FIGS. 14 and/or 15, with the sensor at a distance behind the center screen facing the user. The controllability of one screen will be tested before more screens 46, 48 are added to create the further 3D spatial illusions. That is to say, if one screen is successful and productive, then more screens can be added to give boundary to the spatial volume 48 a single sensor can control; the angle range will be utilized as depicted only if this one sensor is used and/or is available, but any number or combination of types 45, 46 of them may be used. These additional example placed screens 46 would not necessarily be placed as additional computer screens, but can also serve as placeholders for a type of user-occupyable or “computerized space,” regardless of the size and shape of that volume—this can even be the space of whole rooms or buildings. In the example provided, the sensor needs to be behind the screen to yield this proposed sensorized space as the “freespace” in which to create and work with gestures. Of course, the shaded volume will change depending on the exact parameters of the monitor and other components used. This is one of a few advanced scenarios that can be pursued depending on the availability of hardware and additional features.

The evolving example schematic scene will now include an additional section that represents the loops interaction with the whole system when manipulating the sensorized freespace in the volume in front of the user monitor. This diagram also depicts how the sensor(s) will cross paths with the viewable, example API window and interpret the user gesture commands 54, 55 from the user, pass them to the message queue, and then update the monitor view 45, 53, 55. This is the schematic state that will be the ideal goal for this single application of the example variation of the present invention, with the range of the commands, gesture, and/or imagery/video/display to be determined as needed and/or desired for both the gestural freespace and the holographic-type control unit; these can be pre-determined by the system or user, or can be determined as set and needed by the system or user and/or saved for future during live usage—this may also include any combination of the processes.

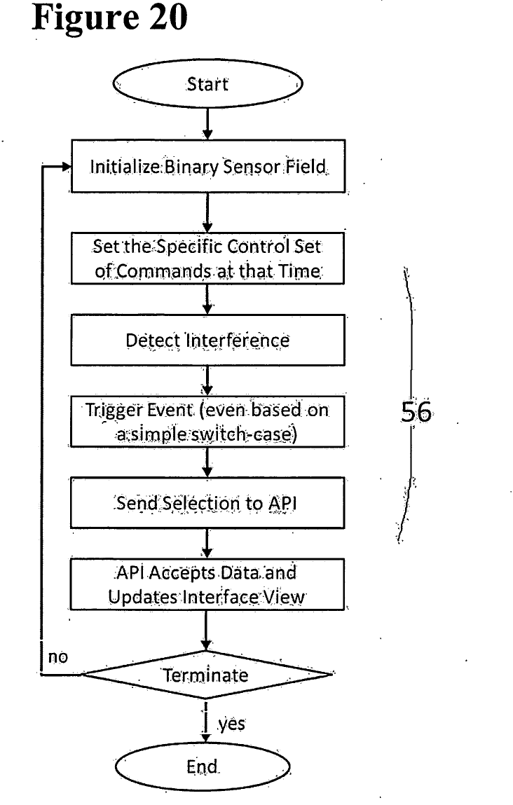

Certain circumstances of functionality for the present invention will require a separate algorithmic solution than the control device uses as a single entity, even though it may execute identically at certain points, and in certain cases the communication between the pieces/components does need to be established. The programming may require multiple combinations of algorithms for the components until one is reached to suffice for the purposes desired or needed by the user(s). This may also be written with any programming language; however, C++/C was used in one prototype for reasons of familiarity as well as transitional purposes into parallel processing. There is also plenty of literature about using sensors in conjunction with parallel processing, which is useful for improving additional prototypes. Starting with the setup as seen in the FIG. 14, with a single screen in use, the general control sequence can be executed with two simultaneous loops 56, as in FIG. 20. In these examples, one of the two loops will detect the instruction and place that instruction onto a queue data structure for the API; the second will take the first item on the queue (or API message loop), analyze it, and send it to update the GUI/API accordingly. Upon disconnection of the apparatus, the remaining items in the queue will be discarded before the program is restarted, see process in FIG. 20.

In particular, another variation of the system would be that which needs further calibration because it is in the realm of using multiple screens to create larger 3D, occupyable space, as in FIG. 15. The gesture identification is easily setup when a user is facing one direction and one direction only; but, in the event of these systems being applied to walls or anything at varying angles, a solution would the scenario of gestures being recognized within the whole sensorized area, as in, multiple screens would be calibrated to process as one combined screen or volume of area, and this would include the functionality of a user rotating him/herself to make some gesture at a range of angles instead of just one angle that is perpendicular to the center screen or sensor. This example variation of the present invention could include a filtering system for the scenario presented here. Another example variation could include the application of these functions and the incorporation of the present invention(s) into whole rooms within buildings, for example, perhaps delineated by distance away from any given wall or surface.

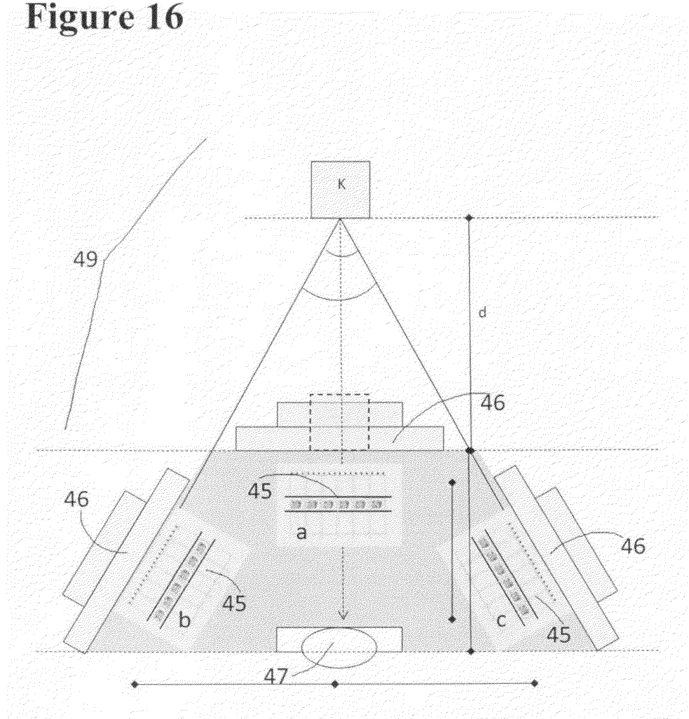

Finally, all of the components need to work together or communicate in order to offer a “full” range of control to the user. In its simplest form—which will be utilized first—the holographic-type control unit(s) 45 would need to be in use along with the sensor(s)/gesture system 46. There are multiple methods of advancing the single versions of each apparatus as depicted in FIGS. 14, 15 and/or 16. For example, more monitor screens 46 could be added. That is, additional screens are not meant to be additional computer screens, but projected to be serving as placeholders for the creation of user-occupyable or “computerized, occupyable space” using holographic-type controller(s) 45 of any of the parameters described in this application or the images or the image descriptions. The multiple screens can be used to define the sensorized space in which the user and the control device interact. There can be variations of exact seat and control device length and position, etc., but the diagrammatic interactions are relevant for this invention without other work being completed first. For example, the results of future work may prove that multiple controllers are useful; this is illustrated in a very simplified version in the following FIG. 16. Three controllers 45 are shown that are all equal in keys and length. This is only one arrangement, size, mirror curvature, overlap, etc., that would be operable; other options could involve one continuous length of control device, a portable control device, or any other type of combination(s).

The combinational algorithms in this one example will work with the two components acting through an interrupt structure such that both have control over the Windows API interchangeably. One possible algorithmic solution would include both components being facilitated and updated after every loop iteration. The mapped algorithms whose process are shown in various ways in FIGS. 19-24, show how the code would need to progress by initializing the spatial locations as well as the associated API current view. These two event loops in these examples are both connected to the main API program (the same way the two loops facilitating holographic-type control device are both connected to this main program). After the two techniques 57, 58, 59 are calibrated so that the real-time effect of a selection in space and the API view update are in synch; the program will produce any number of necessary or desired data logging, parameter passing, or other functions with this new current information. Essentially, the data gathered by the sensor will be tagged and mapped by a certain set of rules to an associated API function which the API main program will accept and process to update the user screen view for this example application. Since this update in these examples will be caused by a user gesture (hand gestures, in this case) made in free space, again without any physical connection to the hardware, the result is a computer API system controlled in freespace without using any keyboard, mouse, or other hardware. At this point, the process of observing gesture commands and updating the API on command will continuously repeat unless the user signals to the systems that program termination is selected.

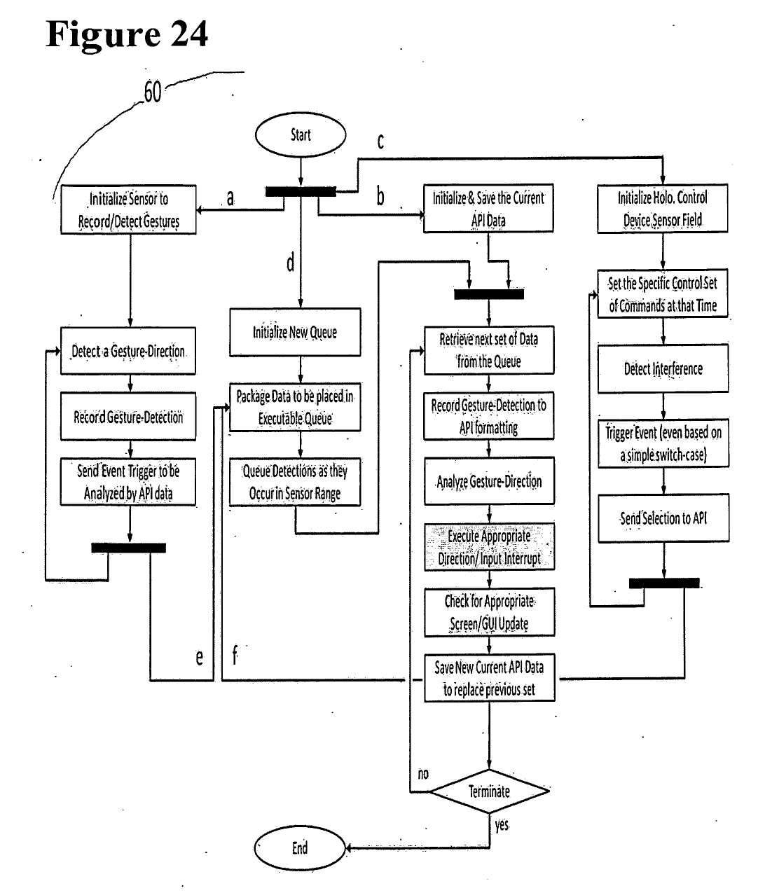

The remaining detailed solution is the algorithm map 60 based on the combination of the required functionalities of the gestural freespace as the process is seen in FIG. 24, and the holographic-type control device. This overall plan for code 60 represents the final schematic illustration/process used in these examples; it captures and includes the combinational nature of the required programmatic functions, but it is not inclusive of all the approaches that may be used or all of the languages that could be used-many alternatives can be used for a similar result. These depict a subset of possible approaches, and the final diagrams of the actual working code will be included in the results of the associated thesis project that goes with this patent application. For the example system shown in FIG. 19, multiple loops will need to be executed upon the program beginning. There is one set of code controlling the initialization and function of the sensor for freespace gestures, and another code/function(s) controlling the current and new API layout, and yet another set of code operating the sensor field of the holographic-type control device; a message loop queue 60 is also established at this time. Each of the individual sections of code will need to be in communication with the other sections of code through different channels, including the main API program that is retrieving its data off of the single queued message loop, although this is only one valid approach in this example of a potential many. In these examples, both of the components observe and detect changes in the sensorized space they are respectively observing. The data gathered by the sensor from each of the two components will pass the tagged event data back to the API message queue for the processing required by this section of the program example. After an item is added to the message queue, the messages are passed through the path 60 and executed such that the API/user screen view is updated. As previously established for this example, the loops continue to accept and pass data and commands until the user ends the program or the program ends of other means, at this point the program stops and will re-initialized all the components when it re-starts.

The results are expected to provide evidence of one method of achieving the control of a Windows API/GUI system solely by needing to interact with the freespace provided; this freespace will replace tools such as a mouse or keyboard as they are used with traditional laptops and desktop computers. Results for this project are expected to provide an understanding and prototype of both of the described components-separately and in combination so as to review the effectiveness of each individually and together. It is important to see the separate approaches that may be required of a touch-free interface system since the APIs/GUIs used for a laptop, for instance, are made up of several techniques already (those including mouse commands, keyboard techniques, voice/facial/biological recognition, etc.).

The results in question regarding the present invention would also show that user benefits can be demonstrated for those not directly involved in the project; the results will make manifest the ideas and interests that have been explored. It will illustrate a solution for certain strains and limitations that traditional laptops and desktops exert on users such as rigid hand angles for typing. It may also be that this prototype could demonstrate itself as a part of a larger system of the future. This means the following: consider a system such as proposed by this project which is completely run and controlled by voice commands/recognition; my results could show a tremendously useful percentage of work that could eventually be a necessary partnership.

The voice recognition options in full or in part could be useful in their own right, but then it would fall short in the areas such as audio-related privacy options, allowing commands to be distinctly separated from any type of speech/general conversation in a room, and accessibility for those with certain speech-related disabilities. In this case, as with many others, my results would show a system which could exist on its own, but one that could also be developed in conjunction with others to meet a/multiple user's all-around needs. This type of work may also benefit a number of other professions by providing new means of construction, navigation, etc. For a more complete summary of potential uses, see the List of Contributions presented later in this application.

The best known method of implementation/method used for the examples seen in this application:

The method or approach of the present invention comes from the pursuit of interactive, viewable, 3D display systems, using similar approaches as well as expanding on some of the ideas presented in the previous pages. The work in the examples shown in this application is best known to be completed in several phases; each one is building upon is predecessor until the main goal is reached.

The present invention draws from several existing works, each altered to achieve a slightly different goal for use with 3D interfaces. The extensions suggested and made will be combined to achieve a holographic-type control unit as well as to orchestrate a 3D interface control space outside of the physical computer hardware. The control unit created first will consist of a physical array of concave mirror slices, as delineated in the above and below sections and in the images as shown in part or whole. For the sake of time and price, the mirrors to be used will be plastic, although any material as described above or below would be suitable to create the effect necessary. Once secured as desired, the selected sensors will be placed and calibrated in combination with the projected holograms/virtual images. For the beginning of this project, components will be constructed to work with a simple laptop screenspace, as the example application used.

The second part of this project will introduce a complete sensor system (at this point the choice is a depth sensor, but others are just as valid) and will be working primarily with gesture recognition (other elements may be used in part too, such as voice recognition), but it will control the visible interface in a similar way as the controller apparatus. This part will not only include holographic-type combinational spaces, but rather will work along side of the controller via the same, open, 3D space that user him/herself occupies.

The overall methods/steps presented below demonstrate the primary example used to accomplish a multi-faceted, 3D display system which will give a convenient level of control to a GUI/API as needed in the example application. This is created via mechanisms, sensors, and programs that produce an environment free of the direct physical contact that most mice, keyboards, etc. require as described in this single example of the invention. The phases as used in this example are performed as follows: 1) A plan will be created for writing code; this will include overall maps of algorithms, classes, etc (translating what is possible into parallel processing and the rest in C++). 2) A small piece of code with one sensor will be written to detect linear distance to an object. 3) Upon taking this data and bringing up the correct linked images, the rest of the hardware for the controller device will be built to hold the accompanying imagery/type(s) of imagery. 4) This coding technique is applied to a set of swapping arrays such that it is combined with and/or connected to GUI/API-type interface data rendered in the associated computer screen. 5) Similar connections will use human movements and apply this technique to the general function of a basic Windows API. This can be done with a depth sensor in this example by first programming one control/gesture (or by using an existing algorithm from a library) and connecting it to the appropriate Windows API functionality (beyond that of image manipulation or resizing). 6) This ability is used with one screen, even if it is a large size and it is solidified. 7) It is connected to the previously created control device allowing typed elements; this will require collaboration of the two types of interactions via interrupts; then one of two courses: (a) it could be expanded into manipulating several surrounding screens at once. OR, (b) it can create additional functionality with other motions to use in the “free space” corresponding to different GUI/API events. 8) Both a) and b) can be developed further depending on the progress of the work & needs/desires or it may be that these events will be best advanced with other types of work or additions to this type of system and/or invention and/or holographic-type control unit. This plan consists of a two-part solution that will interact as a whole in the ideal finished product. The first is the implementation of the 3D Holographic-type Freespace Control Unit (HFCU), and the Gesture-Controlled 3D Interface Freespace (GCIF).

Useful additions to the present invention or uses for the invention are listed below; this is not a complete list of possibilities but it does demonstrate some more of the unique possibilities which the present invention is capable of fulfilling. Additions to the project could include elements such as programming for other major OS APIs. Furthermore, this could function as one cohesive program that can act as a layer running on top of any computer interface at will. Another possibility for future work would be in expanding the range or library of commands through which the components function, as well as increasing the numbers and types of holograms/virtual images produced, or by using a variety of holographic-type source mediums. The present invention could use an increased number of commands and could be expanded to include as many as exist in a normal API or GUI or even generate some new functionality made specifically for the designed components. All of these can be combined into a single “library” and used as needed through the 3D freespace/holographic-type interface. There could also be merit in creating such systems that function for different types of browser functions or online activities or applications or databases, etc. This may or may not be an endeavor all on its own depending upon the depth of the command library at the time of investigation. The image of the entire screened interface can be turned into the virtual holographic-type image so as to incorporate both components into a single unit, or for it to be mapped onto external additional components. In this scenario, all of these endeavors may be able to be combined to perform from the same library of commands including operating systems, command types, browser functions, and anything else that may become of interest to a user(s).

There are a variety of uses for this type of invention, depending on the parameters used in its construction and implementation. The following is a list of some of these functions, but is not inclusive of every possibility; some of these contributions and options are as follows: these allow for the creation of a type of holographic-type control unit, these can create a 3D, human occupied space, acting itself as an interface control system, this approach provides freedom from the hardware (mouse, keyboard, etc.), the freedom from the hardware reduces ergonometric strain, setup allows future work to be improved for parallel computing (image side), setup allows future work to be improved for parallel computing (screen rendering side), setup allows future work to be improved for parallel computing (sensor field side), these will show both 2D and 3D applications of free-space API controls, could create a type of bridge between usage of current APIs, these is not dependent on human/finger touch (i.e. could use a # of moving objects eventually), these could become a layer acting on top of any OS, these would have similar benefits to other holographic-type media, the limits of certain parts of this system could act as beneficial in terms of security in the future, in the future, could offer a new method to control an interface off-site via video feed, this could build on the vast gaming application techniques, industry uses outside computing addressing security issues, hygienic issues, etc., architectural design Implications (personal & previous studies), and/or virtual reality spaces which are free of needing head-piece(s), and so on.

### REFERENCES

### Incorporated Herein by Reference

Not Used in the Application: Components can be of various types and makers (including personal make) to achieve the function of the present invention.

I claim:

1. A method for creating an interactive holographic-type/virtual image control device or series of virtual images, the method comprising:
step a: create and arrange mirrors in any number, direction, overlap, scale, distance, proximity, curved based on any mathematical equation, and/or creating the hologram(s)/virtual image(s) at any distance from the invention;
step b: setup and calibrate source of the hologram(s) or real object(s), including the source hardware, projectors, screens, reflections, and any other elements necessary to adjust and create the holograms/virtual images;
step c: create and run the necessary code to correspond information or data of the sensor(s) and connect the necessary sensors and other electronic devices needed;
step d: place sensors of the chosen type(s) to input and output the needed data from the necessary volume of space; this will, at times, be the same volumes of space in which the holograms/virtual images reside;
step e: create and run the necessary code to correspond information or data of the real object(s) or the real-object generation source and components, also connect the necessary projectors, screens, and/or any other electronic devices needed;
step f: place real-object generation source and components of the chosen type(s) to input and output the needed data from the necessary volumes of space; this will, at times, be the same volume of space in which the holograms/virtual images reside or outside of it;
step g: calibrate the systems to function as desired when certain designated gestures are executed within the sensor-monitored spaces and/or holograms/virtual images.

2. A SENSOR-MONITORED, 3D, INTERACTIVE HOLOGRAPHIC-TYPE FREESPACE CONTROL UNIT (HFCU) that provides a holographic-type user interface that is operable via interactions with the holograms/virtual images and/or sensor(s), said SENSOR-MONITORED, 3D, INTERACTIVE HOLOGRAPHIC-TYPE FREESPACE CONTROL UNIT (HFCU) comprising:
a feature 1: concave and/or convex mirror slices in any number, direction, overlap, scale, distance, proximity, curved based on any mathematical equation, an/or creating the desired size, shape, location, and repetition of holograms/virtual images at any distance from the invention;
a feature 2: real object source components: this is implemented in the prototype via a second opening, potentially used for video, alternating real objects, and/or any material to create the real object to reflect or a surface to project images onto: one prototype uses a translucent vellum to project images onto which in turn become the interactive hologram/virtual image(s);
a feature 3: the sensor(s) or camera(s) placed and used to collect data, mostly via gesture recognition and depth changes, these can be one or many devices of any make however a depth sensor was used to create one prototype for the present invention, these, at least in part, will be used to observe the same time and volume of space in which the hologram and/or virtual images reside;
a feature 4: any power cables, connectors, and adapter required to connect the various pieces of this invention together, also any of these items needed to implement the associated code;
a feature 5: the code(s) that controls the input and output and execution of any event of the components and/or overall system;
a feature 6: the processes for the algorithms used in the current prototypes, as seen in the FIGS. 17-24;
a feature 7: any additional points shown in FIGS. 1-24;
a feature 8: the holograms/virtual images in the volume(s) of space and surrounding space they occupy, these can be static, operable to be switched by the user, operable via voice commands, combined with voice commands, self changing/updated, or changed in real time or via video feed, or any combination thereof;
a feature 9: the casing or mounting features to install invention at any location and/or the construction and/or furnishing specifically needed in which these parts would be mounted.
